(19) United States
(12) Patent Application Publication
(10) Pub. No.: US 2013/0221882 A1
(43) Pub. Date: Aug. 29, 2013

(54) MOTOR DRIVING CIRCUIT, MOTOR DRIVING APPARATUS HAVING THE SAME, AND MOTOR DRIVING METHOD

(71) Applicant: SAMSUNG ELECTRO-MECHANICS CO., LTD., (US)

(72) Inventor: Bon Young Gu, Gyeonggi-do (KR)

(73) Assignee: SAMSUNG ELECTRO-MECHANICS CO., LTD., Gyeonggi-do (KR)

(21) Appl. No.: 13/773,531

(22) Filed: Feb. 21, 2013

(30) Foreign Application Priority Data
Feb. 29, 2012 (KR) 10-2012-0021016

(51) Int. Cl. H02P 6/08

(52) U.S. Cl. CPC H02P 6/08
USPC 318/400.13

(57) ABSTRACT

Disclosed herein is a motor driving circuit including: a duty ratio detection unit that detects a duty ratio of input pulse-width-modulation applied to control a speed of a motor; a speed detection unit that detects the speed of the motor; and a driving control unit that detects a targeted speed corresponding to the duty ratio of the input pulse-width-modulation by using relationship data between the duty ratio of the input pulse-width-modulation and the targeted speed that are previously stored and controls a driving of the motor so that the speed of the motor is equal to the targeted speed. By this configuration, a speed of the motor can be accurately controlled.

### CROSS REFERENCE(S) TO RELATED APPLICATIONS

This application claims the benefit under 35 U.S.C. Section 119 of Korean Patent Application Serial No. 10-2012-0021016, entitled “Motor Driving Circuit, Motor Driving Apparatus Having The Same, and Motor Driving Method” filed on Feb. 29, 2012, which is hereby incorporated by reference in its entirety into this application.

### BACKGROUND OF THE INVENTION

1. Technical Field

The present invention relates to a motor driving circuit capable of controlling a motor at a desired speed, a motor driving apparatus having the same, and a motor driving method.

2. Description of the Related Art

Generally, a motor means a device that is used in various fields from home appliances such as a refrigerator, an air conditioner, or the like, to an information processing device such as a disk driver. A motor capable of controlling speed such as a brushless direct current (BLDC) motor can control speed by controlling a duty ratio of a pulse-width-modulation (PWM) signal.

Meanwhile, a speed control scheme of a motor may be largely classified into a closed loop control scheme and an open loop control scheme. The open loop control scheme does not include the feedback circuit and therefore, may be implemented in a simple structure, but cannot compensate for errors occurring due to external operating environments such as electrical noise, change in temperature, or the like.

On the other hand, the closed loop control scheme includes a feedback circuit to detect current revolution per minute (RPM), speed, and surrounding operating environments, or the like, of the motor and controls an input signal from the detection to control errors occurring during the operation of the motor. Consequently, the closed loop control scheme needs to include a circuit for detecting the current RPM, speed, or the like, of the motor and needs to additionally include a voltage detection circuit and an error compensation circuit for coping with external operating environments, or the like.

Therefore, complexity of a motor driving circuit is increased and when the voltage detection circuit, the error compensation circuit, or the like, are excluded from the circuit configuration, it is difficult to accurately reflect the changes according to the external operating environments upon detecting the RPM and speed of the motor.

### Related Art Document

Korean Patent Laid-Open Publication No. 2006-0070257

### SUMMARY OF THE INVENTION

An object of the present invention is to provide a motor driving circuit capable of accurately controlling a speed of a motor according to external operating environments without adding or changing separate circuits by using relationship data between a duty ratio of input pulse-width-modulation and a targeted speed that are stored in the motor driving circuit, a motor driving apparatus having the same, and a motor driving method.

According to an exemplary embodiment of the present invention, there is provided a motor driving circuit, including: a duty ratio detection unit that detects a duty ratio of input pulse-width-modulation applied to control a speed of a motor; a speed detection unit that detects the speed of the motor; and a driving control unit that detects a targeted speed corresponding to the duty ratio of the input pulse-width-modulation by using relationship data between the duty ratio of the input pulse-width-modulation and the targeted speed that are previously stored and controls a driving of the motor so that the speed of the motor is equal to the targeted speed.

The motor driving circuit may further include: a storage unit in which the relationship data between the duty ratio of the input pulse-width-modulation and the targeted speed are stored.

The storage unit may store the relationship data between the duty ratio of the input pulse-width-modulation and the targeted speed in a look up table form.

The storage unit may store the relationship data between the duty ratio of the input pulse-width-modulation and the targeted speed in a linear function form of the targeted speed with respect to the duty ratio of the input pulse-width-modulation.

The linear function of the targeted speed with respect to the duty ratio of the input pulse-width-modulation may be represented by the following <Equation>.

Targeted speed=Duty ratio of input pulse-width-modulation×Slope a+Constant b, <Equation>

where b is a minimum value of the targeted speed.

The relationship data between the duty ratio of the input pulse-width-modulation and the targeted speed may be configured in a form in which a plurality of linear functions having different slopes for each section of the duty ratio of the input pulse-width-modulation are combined with one another.

The storage unit may store the relationship data between the duty ratio of the input pulse-width-modulation and the targeted speed in a form in which the look up table and the linear function of the targeted speed with respect to the duty ratio of the input pulse-width-modulation are combined with each other.

The driving control unit may include: a detector that detects the targeted speed corresponding to the duty ratio of the input pulse-width-modulation by using the relationship data between the duty ratio of the input pulse-width-modulation and the targeted speed; and a comparator that compares the speed of the motor with the targeted speed to ouput the comparison results.

The driving control unit may further include: a controller that controls a duty ratio of a driving signal applied to the motor by using the comparison results; and a driver that controls the driving of the motor so that the speed of the motor becomes the targeted speed by using the duty ratio of the driving signal.

The controller may perform a control to reduce the duty ratio of the driving signal when the speed of the motor is faster than the targeted speed in the comparison results and perform a control to increase the duty ratio of the driving signal when the speed of the motor is slower than the targeted speed in the comparison results.

The relationship data between the duty ratio of the input pulse-width-modulation and the targeted speed may be stored by previously reflecting error information for compensating for errors of the speed of the motor detected by the speed detection unit or the duty ratio of the input pulse-width-modulation detected by the duty detection unit.

According to another exemplary embodiment of the present invention, there is provided a motor driving apparatus, including: an external control circuit that generates and outputs input pulse-width-modulation as a command for controlling a motor at a desired speed; and a motor driving circuit that receives the input pulse-width-modulation to detect a duty ratio of the input pulse-width-modulation, detects a speed of the motor, detects a targeted speed corresponding to the duty ratio of the input pulse-width-modulation by using relationship data between the duty ratio of the input pulse-width-modulation and the targeted speed that are previously stored, and controls a driving of the motor so that the speed of the motor is equal to the targeted speed.

The motor driving circuit may include: a storage unit in which the relationship data between the duty ratio of the input pulse-width-modulation and the targeted speed are stored.

The storage unit may store the relationship data between the duty ratio of the input pulse-width-modulation and the targeted speed in a look up table form.

The storage unit may store the relationship data between the duty ratio of the input pulse-width-modulation and the targeted speed in a linear function form of the targeted speed with respect to the duty ratio of the input pulse-width-modulation.

The linear function of the targeted speed with respect to the duty ratio of the input pulse-width-modulation is represented by the following <Equation>.

Targeted speed=Duty ratio of input pulse-width-modulation×Slope a+Constant b, <Equation>

where b is a minimum value of the targeted speed.

The relationship data between the duty ratio of the input pulse-width-modulation and the targeted speed may be formed in a form in which a plurality of different linear function having different slopes for each section of the duty ratio of the input pulse-width-modulation are combined with one another.

The storage unit may store the relationship data between the duty ratio of the input pulse-width-modulation and the targeted speed in a form in which the look up table and the linear function of the targeted speed with respect to the duty ratio of the input pulse-width-modulation are combined with each other.

According to another exemplary embodiment of the present invention, there is provided a motor driving method, including: detecting a duty ratio of input pulse-width-modulation applied to control a speed of a motor; detecting the speed of the motor; detecting a targeted speed corresponding to the duty ratio of the input pulse-width-modulation by using relationship data between the duty ratio of the input pulse-width-modulation and a targeted speed that are previously stored; and controlling a driving of the motor so that the speed of the motor is equal to the targeted speed.

The motor driving method may further include: after the detecting of the targeted speed, comparing the speed of the motor with the targeted speed to output the comparison results.

At the controlling of the driving of the motor, the duty ratio of the driving signal applied to the motor may be controlled by using the comparison results.

At the controlling of the duty ratio of the driving signal, a control may be performed to reduce the duty ratio of the driving signal when the speed of the motor is faster than the targeted speed in the comparison results and a control may be performed to increase the duty ratio of the driving signal when the speed of the motor is slower than the targeted speed in the comparison results.

### BRIEF DESCRIPTION OF THE DRAWINGS

FIG. 1 is a schematic configuration diagram of a motor driving apparatus in accordance with an exemplary embodiment of the present invention.

FIG. 2 is a detailed configuration diagram of the motor driving circuit shown in FIG. 1.

FIGS. 3A and 3B are diagrams showing relationship data stored in a storage unit of FIG. 2 in a look up table form.

FIG. 3A is a diagram showing a targeted speed with respect to a duty ratio of input pulse-width-modulation.

FIG. 3B is a diagram showing the targeted speed with respect to an address.

FIGS. 4A to 4F are diagrams showing the relationship data stored in a storage unit of FIG. 2 in a linear function form.

FIG. 4A is a diagram showing a relationship graph between the duty ratio of the input pulse-width-modulation and the targeted speed.

FIG. 4B is a diagram showing information stored in the storage unit of FIG. 2.

FIGS. 4C and 4F are diagrams showing various examples of a relationship graph between the duty ratio of the input pulse-width-modulation and the targeted speed.

FIGS. 5A to 5B are diagrams showing the relationship data stored in the storage unit of FIG. 2 by a combination of the look up table form and the linear function form.

FIG. 6 is a diagram showing a process of driving a motor.

FIG. 7 is an operational flow chart showing a motor driving process in accordance with the exemplary embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described with reference to the accompanying drawings.

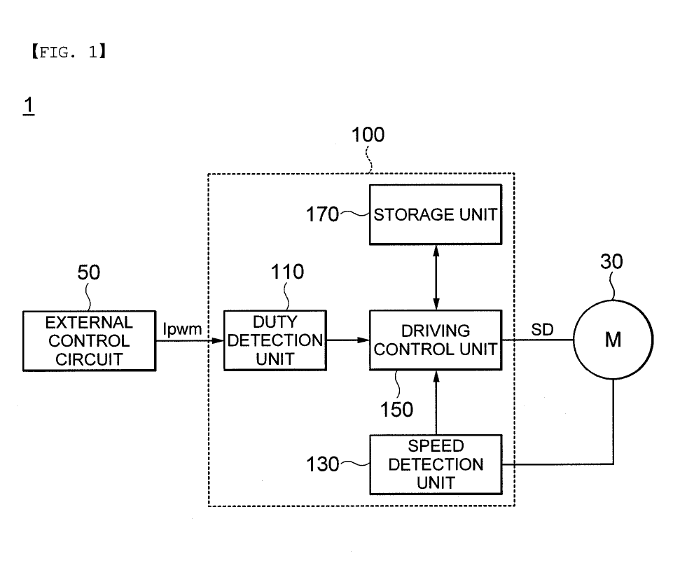

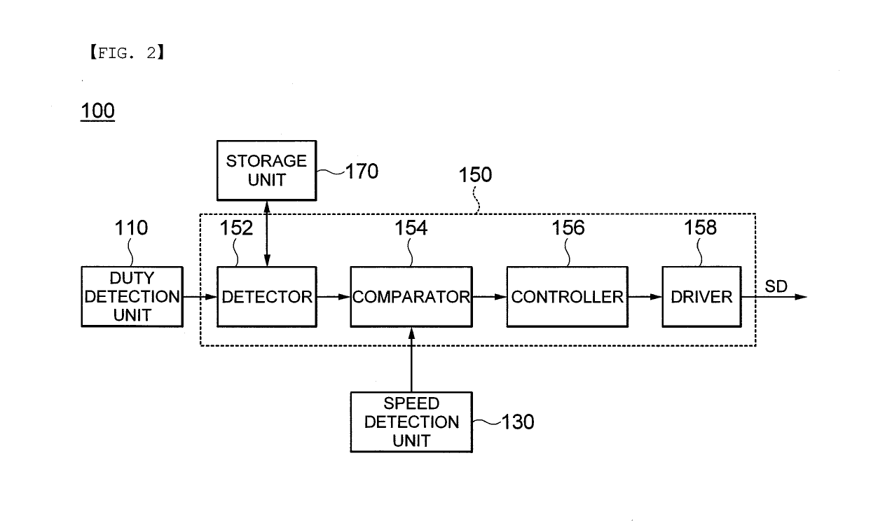

FIG. 1 is a schematic configuration diagram of a motor driving apparatus in accordance with an exemplary embodiment of the present invention and FIG. 2 is a detailed configuration diagram of the motor driving circuit shown in FIG. 1.

As shown in FIGS. 1 and 2, a motor driving apparatus 1 is configured to include an external control circuit 50 and a motor driving circuit 100.

First describing a motor, a motor 30 may be a brushless direct current (BLDC) motor, or the like. The BLDC motor is a brushless motor among direct current (DC) motors, wherein a rotator may be configured of a permanent magnet and a stator at the outside of the motor may be configured of an electromagnet.

The external control circuit 50 is a unit that generates input pulse-width-modulation that is a command for controlling the motor 30 at a desired speed and transmits the generated input pulse-width-modulation to the motor driving circuit 100. In this case, the input pulse-width-modulation Ipwm is generated regardless of driving environment of the motor and thus, the motor is not affected by a change in external operating environments such as a change in temperature, or the like.

The motor driving circuit 100, which is a unit of controlling the motor 30 at a desired speed, is configured to include a duty detection unit 110, a speed detection unit 130, a driving control unit 150, and a storage unit 170.

The duty detection unit 110, which is a unit of detecting a duty ratio of the input pulse-width-modulation Ipwm, detects turn-on time at which a signal has a high value within one period of the input pulse-width-modulation Ipwm and turn-off time at which a signal has a low value, thereby detecting the duty ratio of the input pulse-width-modulation Ipwm.

In other words, the duty detection unit 110 can detect the duty ratio of the input pulse-width-modulation Ipwm that is a ratio of the turn-on time having the high value within one period of the input pulse-width-modulation-signal Ipwm from a period of the input pulse-width-modulation Ipwm and the timing having the high value.

The speed detection unit 130 detects the speed of the motor 30 from the RPM of the motor 30. In more detail, the speed detection unit 130 is configured to include a Hall sensor, or the like, to use a rotation position of a rotator of the motor 30 varying over time, thereby making it possible to detect a current speed of the motor 30.

In this case, the speed of the motor 30 needs to be maintained at a targeted speed designated by a user and therefore, the general operation of the motor driving circuit 100 needs to detect the speed of the motor 30. Herein, when the detected speed is faster than the targeted speed, the driving control unit 150 controls a driving signal SD output to the motor 30 to reduce the speed of the motor 30, while when the detected speed of the motor 30 is slower than the targeted speed, the driving control unit 150 increases the speed of the motor 30.

The driving control unit 150, which is a microcomputer that generally controls the motor driving circuit 100, is configured to include a detector 152, a comparator 154, a controller 156, and a driver 158.

Among others, the detector 152 detects the targeted speed corresponding to the duty ratio of the input pulse-width-modulation Ipwm by using relationship data between the duty ratio of the input pulse-width-modulation Ipwm and the targeted speed that are stored in the storage unit 170.

That is, the detector 152 can read the targeted speed of the motor 30 corresponding to the duty ratio of the input pulse-width-modulation Ipwm by referring to corresponding relationship between the duty ratio of the input pulse-width-modulation Ipwm and the targeted speed of the motor 30 that are previously prepared in a data table, or the like, or can detect the targeted speed of the motor 30 according to the duty ratio of the input pulse-width-modulation Ipwm by performing direct operation according to a specific formula.

Describing in detail the storage unit 170 prior to describing an operation of the detector 152, the storage unit 170 is a unit in which the relationship data between the duty ratio of the input pulse-width-modulation Ipwm and the targeted speed are stored and may be configured to include a volatile memory or a non-volatile memory. In addition, the storage unit 170 may be configured of a flip flop. In this case, the flip flop, which is a memory used for a sequential logic circuit, may be configured to determine an output in response to a clock signal.

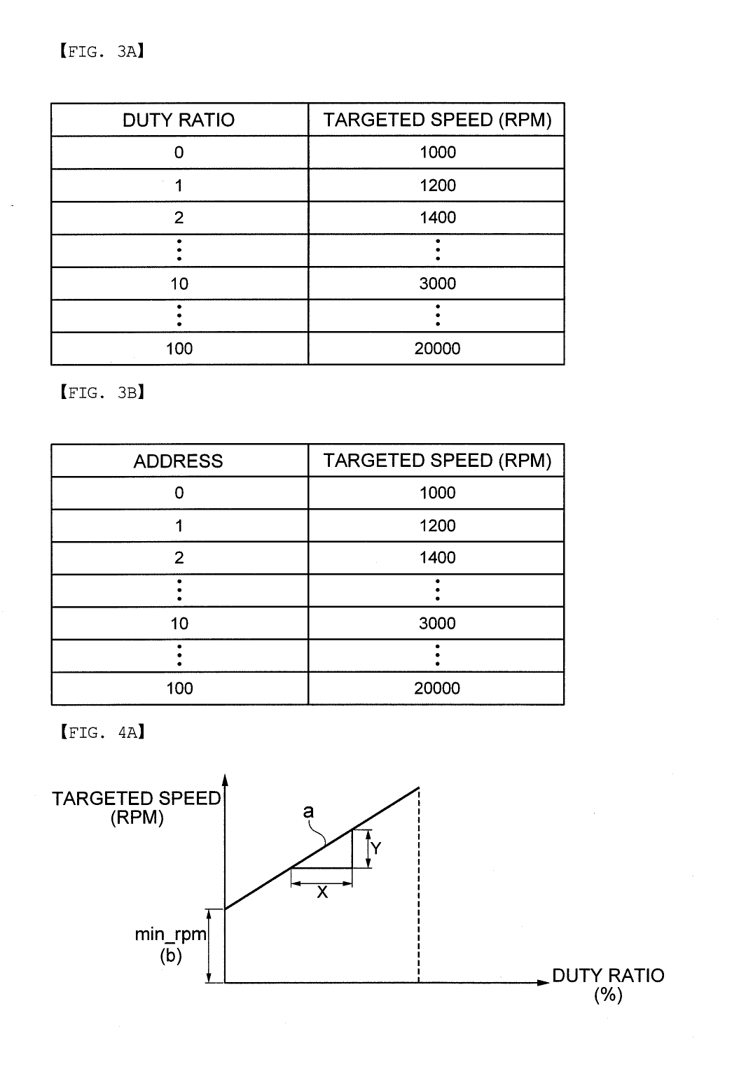

FIGS. 3A and 3B are diagrams showing the relationship data stored in the storage unit of FIG. 2 in a look-up table form.

Referring to FIG. 3A, the storage unit 170 may store the relationship data between the duty ratio of the input pulse-width-modulation Ipwm and the targeted speed in the look up table form. For example, when 101 duty ratios of the input pulse-width-modulation Ipwm from 0 to 100% are stored, 101 targeted speeds corresponding to the duty ratios of each input pulse-width-modulation Ipwm may be stored in an RPM form.

Further, as shown in FIG. 3B, the storage unit 170 does not directly store the duty ratio of the input pulse-width-modulation Ipwm but the targeted speed may be stored in an address corresponding to the duty ratio of the input pulse-width-modulation Ipwm.

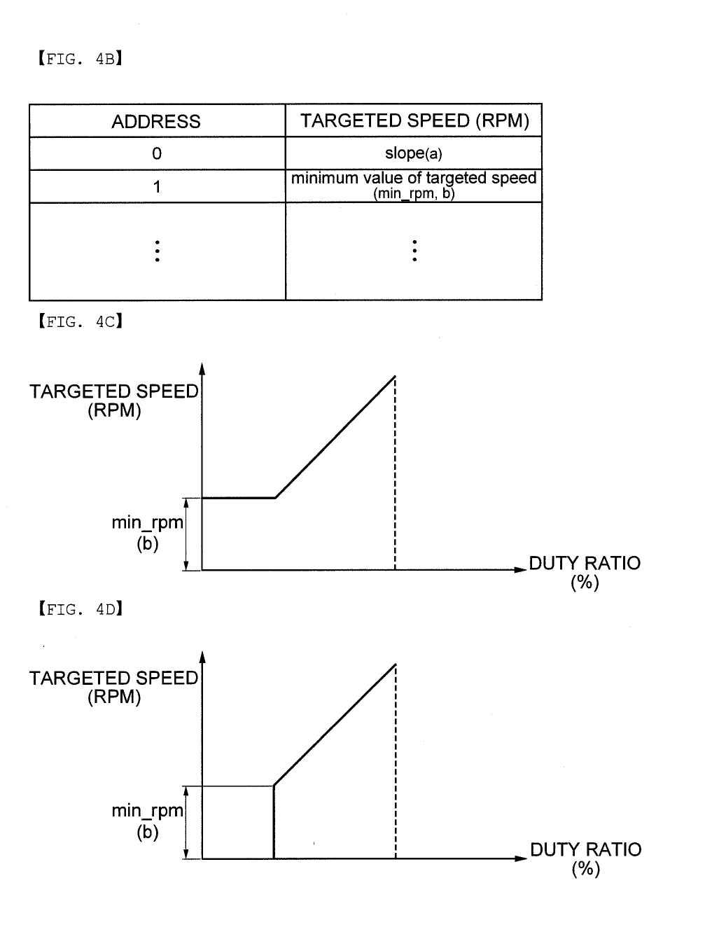

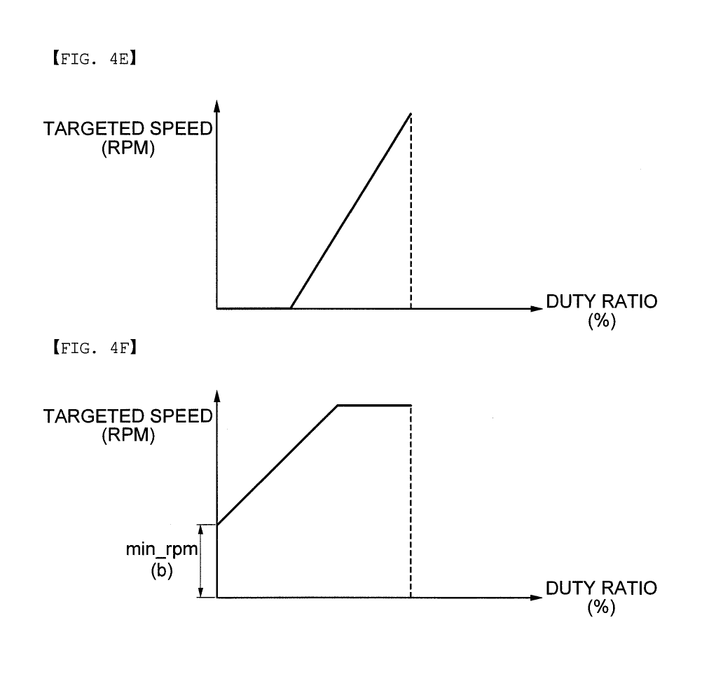

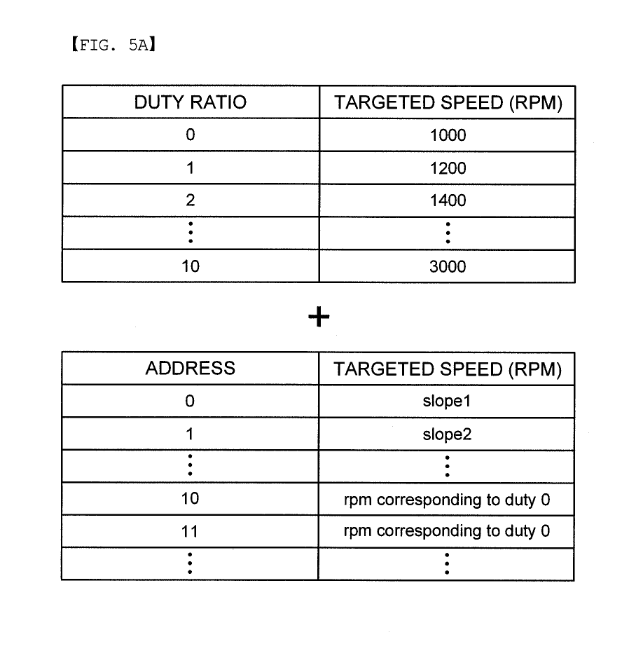

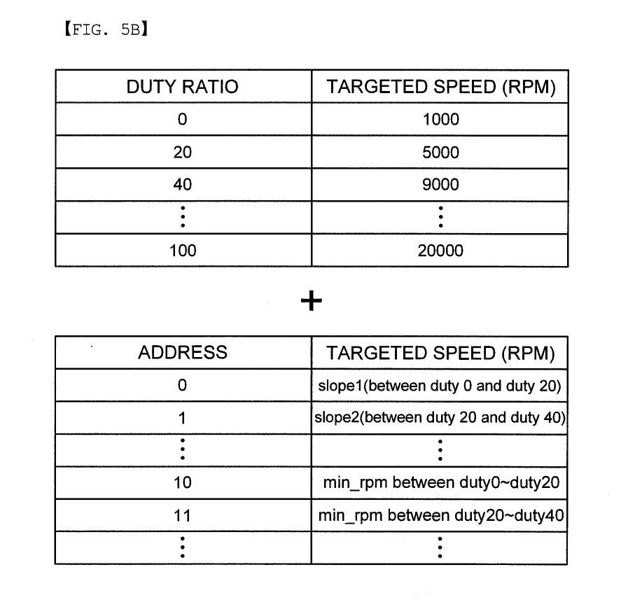

FIGS. 4A to 4F are diagrams showing the relationship data stored in the storage unit of FIG. 2 in a linear function form, wherein FIG. 4A is a diagram showing a relationship graph between the duty ratio of the input pulse-width-modulation and the targeted speed. In this case, the storage unit 170 may store the targeted speed with respect to the duty ratio of the input pulse-width-modulation Ipwm in a linear function form.

In this case, the linear function of the targeted speed with respect to the duty ratio of the input pulse-width-modulation Ipwm may be represented by the following <Equation>.

Targeted speed=Duty ratio of input pulse-width-modulation×Slope a+Constant b <Equation>

In the above Equation, the slope a represents an increment Y of the targeted speed/an increment X of the duty ratio of the input pulse-width-modulation and the constant b represents a minimum value min rpm of the targeted speed.

As such, in order to detect the targeted speed corresponding to the duty ratio of the input pulse-width-modulation Ipwm, the storage unit 170 may store the slope a and the minimum value b of the targeted speed as shown in FIG. 4B and when the duty ratio of the input pulse-width-modulation Ipwm is detected, the targeted speed can be detected by using the slope a and the minimum value b of the targeted speed that are stored in the storage unit 170.

FIGS. 4C and 4F are diagrams showing various examples of a relationship graph between the duty ratio of the input pulse-width-modulation and the targeted speed. As shown in FIGS. 4C and 4F, the relationship graph, that is, the linear function of the targeted speed with respect to the duty ratio of the input pulse-width-modulation Ipwm may be variously set according to the characteristics of the motor.

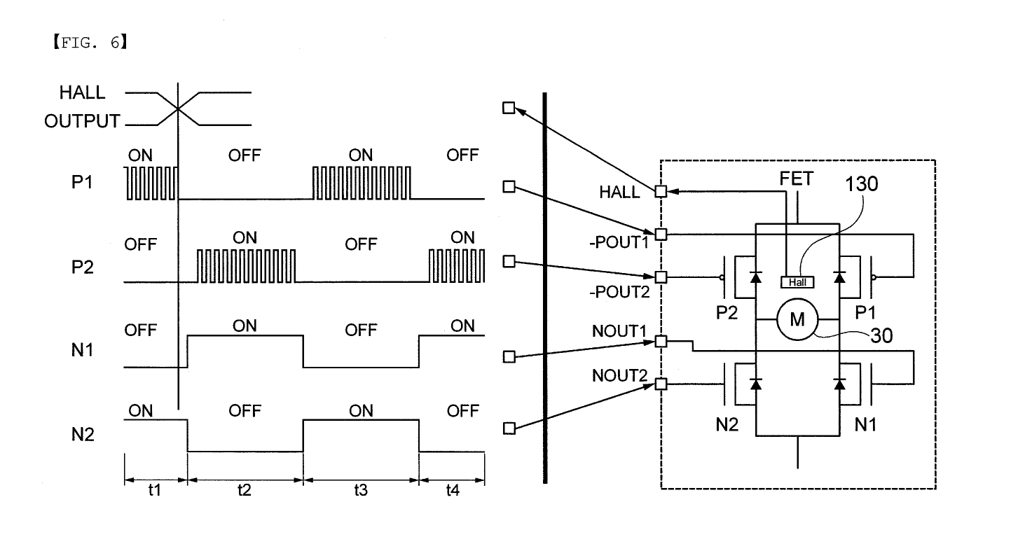

FIGS. 5A and 5B are diagrams showing the relationship data stored in the storage unit of FIG. 2 by a combination of a look-up table form and a linerar function form. As shown in FIGS. 5A and 5B, the storage unit 170 may store the relationship data between the duty ratio of the input pulse-width-modulation Ipwm and the targeted speed in a form in which the look up table and the linear function of the targeted speed with respect to the duty ratio of the input pulse-width-modulation are combined with each other. In this case, at least two slopes and minimum values of the targeted speed may be stored, but other values may be applied according to the duty ratio of the input pulse-width-modulation. Describing in more detail referring to FIG. 5C, the relationship data between the duty ratio of the input pulse-width-modulation and the targeted speed may be configured in a form in which the plurality of linear functions having different slopes for each section of the duty ratio of the input pulse-width-modulation are combined with one another. For example, if a first duty ratio ID1 of the input pulse-width-modulation is 20, when the first duty ratio of the input pulse-width-modulation corresponds to a section of 0 to 22, slope 1 may be applied and if a second duty ratio of the input pulse-width-modulation is 45, when the second duty ratio of the input pulse-width-modulation corresponds to a section of 22 to 45, slope 2 may be applied. In this case, when the duty ratio of the input pulse-width-modulation is 22, results of Equation of section 1 and Equation of section 2 are the same, which may have a form of a continuous graph.

Meanwhile, the relationship data between the duty ratio of the input pulse-width-modulation and the targeted speed that are stored in the storage unit 170 may previously reflect the error information for compensating for the errors of the speed of the motor detected by the speed detection unit 130 or the duty ratio Ipwm of the input pulse-width-modulation detected by the duty detector 110.

Describing in more detail, the speed of the motor is controlled by the current speed of the motor detected by the speed detection unit 130 or the duty ratio of the input pulse-width-modulation detected by the duty detection unit 110, such that errors may occur in the speed control of the motor when there are errors in the speed detection unit 130 and the duty detection unit 110. Therefore, the exemplary embodiment of the present invention sets or stores the relationship data between the duty ratio Ipwm of the input pulse-width-modulation and the targeted speed in the storage unit 170 or when the targeted speed to be described below is detected, the errors occurring in the speed detection unit 130 and the duty detection unit 110 may be reflected.

That is, when the current speed of the motor detected by the speed detection unit 130 is faster by 10% than the actual speed, the targeted speed corresponding to the duty ratio of the input pulse-width-modulation Ipwm may be set by reducing approximately 10%.

Meanwhile, again describing components of the driving control unit 150 with reference to FIG. 2, a comparator 154 compares the speed of the motor detected by the speed detection unit 130 and the targeted speed stored in the storage unit 170 and transfers the comparison results to a controller 156 to control the driving signal SD output to the motor 30 to reduce the speed of the motor 30 when the detected speed of the motor is faster than the targeted speed and increase the speed of the motor 30 when the detected sped of the motor 30 is slower than the targeted speed.

That is, when both of the speed detection unit 130 and the detector 152 transfer data in the speed format of the motor 30, the comparator 154 simply compares the data and transfers the compared data to the controller 156 whether the speed detected b the speed detection unit 130 is larger than the targeted speed of the detector 152.

The controller 156 controls the duty ratio of the driving signal SD applied to the motor 30 so as to control the speed of the motor to be set to the targeted speed using the comparison results in the comparator 154. In this case, the driving signal SD may be also generated in the pulse-width-modulation. In this case, the current speed of the motor 30 is determined by the duty ratio of the driving signal SD. Herein, when the duty ratio of the driving signal SD is increased, the current speed of the motor 30 is increased and when the duty ratio of the driving signal SD is reduced, thee current speed of the motor 30 is reduced.

That is, the controller 156 performs a control to reduce the duty ratio of the driving signal SD when the current speed of the motor 30 is faster than the targeted speed in the comparison results and performs a control to increase the duty ratio of the driving signal SD when the current speed of the motor 30 is slower than the targeted speed in the comparison results.

A driver 158, which is a unit controling the driving of the motor by using the duty ratio of the driving signal SD, controls the on/off operation of a plurality of switches P1, P2, N1, and N2 that controls the driving of the motor 30.

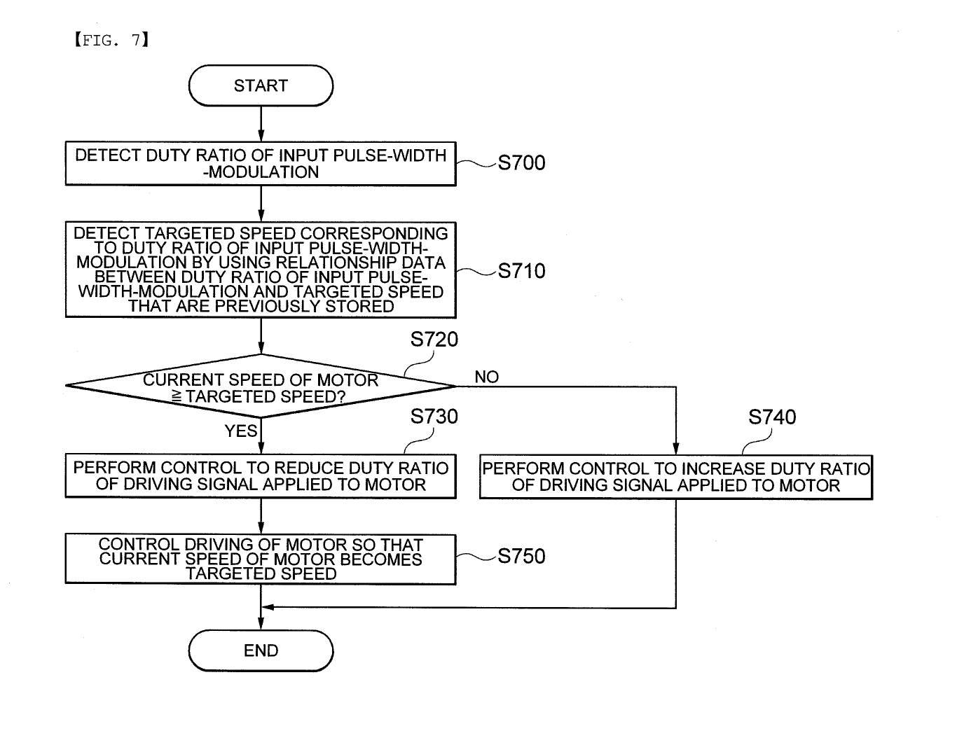

FIG. 6 is a diagram showing a process of driving a motor.

FIG. 6 shows first and second PMOS signals and first and second NMOS signals so as to rotate a single phase BLDC motor forward or reverse. First and second P switches P1 and P2 are turned-on when an input has a low value and first and second N switches N1 and N2 are turned-on when an input has a high value. A signal waveform of FIG. 6 shows that when the first and second P switches P1 and P2 and the first and second N switches N1 and N2 have a high value, these switches art turned-on. The first and second PMOS signals are inverted and are applied to the first and second P switches P1 and P2.

At first and third sections t1 and t3, the first p switch P1 and the second N switch N2 are turned-on and at second and fourth section t2 and t4, the second P switch P2 and the first N switch N1 are turned-on. The driver 158 serves to turn-on/off the plurality of switches P1, P2, N1, and N2 according to a sequence so as to rotate the motor 30.

That is, the first and second PMOS signals are turned-on/off by the driver 158. When they are turned-on, the driving signal is output according to the duty ratio controlled by the controller 156 and when the duty ratio is 100%, the first and second PMOS signals show the same waveform as the first and second NMOS signals.

When the duty ratio is 50% in a first section t1, only 50% of current may flow for a turn-on section of the first PMOS signal and therefore, the current speed of the motor 30 is reduced as current flows in the motor 30. The current speed of the motor 30 can be controlled according to the duty ratio to which the first and second PMOS signals are applied.

Hereinafter, a process of driving the motor in accordance with the exemplary embodiment of the present invention will be described.

FIG. 7 is an operational flow chart showing a motor driving process in accordance with the exemplary embodiment of the present invention. Referring to FIG. 7, the duty ratio of the input pulse-width-modulation applied to control the speed of the motor is detected (S700).

Next, the targeted speed corresponding to the duty ratio of the input pulse-width-modulation are detected by using relationship data between the duty ratio of the input pulse-width-modulation and the targeted speed that are previously stored (S710).

In this case, it can read the targeted speed of the motor 30 corresponding to the duty ratio of the input pulse-width-modulation Ipwm by referring to corresponding relationship between the duty ratio of the input pulse-width-modulation Ipwm and the targeted speed of the motor 30 that are previously prepared in a data table, or the like, or can detect the targeted speed of the motor 30 according to the duty ratio of the input pulse-width-modulation Ipwm by performing direct operation according to a specific formula.

Next, the comparison results are output by comparing the speed of the motor with the targeted speed (S720) and the duty ratio of the driving signal SD applied to the motor 30 is controlled by using the comparison results.

Describing in more detail, when the current speed of the motor is faster than the targeted speed in the comparison results (‘Yes’ at S720), a control is performed to reduce the duty ratio of the driving signal (S730) and when the current speed of the motor is slower than the targeted speed in the comparison results (‘No’ at S720), a control is performed to increase the duty ratio of the driving signal (S740).

Next, a control is performed to drive the motor so that the current speed of the motor is equal to the targeted speed (S750).

As set forth above, according to the motor driving circuit, the motor driving apparatus having the same, and the motor driving method in accordance with the exemplary embodiments of the present invention, the speed of the motor can be accurately controlled according to the external operating environments (voltage, load, or the like) without adding or changing separate circuits by using the relationship data between the duty ratio of the input pulse-width-modulation and the targeted speed that are stored in the motor driving circuit.

In addition, the speed of the motor can be accurately controlled without the error compensation circuit by previously detecting the errors occurring in the circuit of detecting the duty ratio of the input pulse-width-modulation or detecting the speed of the motor to reflect the relationship data between the duty ratio of the input pulse-width-modulation and the targeted speed.

Therefore, the manufacturing costs of the motor driving circuit and the motor driving apparatus having the same can be saved.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims include even another embodiment.

What is claimed is:

1. A motor driving circuit, comprising:
a duty ratio detection unit that detects a duty ratio of input pulse-width-modulation applied to control a speed of a motor;
a speed detection unit that detects the speed of the motor; and
a driving control unit that detects a targeted speed corresponding to the duty ratio, of the input pulse-width-modulation by using relationship data between the duty ratio of the input pulse-width-modulation and the targeted speed that are previously stored and controls a driving of the motor so that the speed of the motor is equal to the targeted speed.

2. The motor driving circuit according to claim 1, further comprising: a storage unit in which the relationship data between the duty ratio of the input pulse-width-modulation and the targeted speed are stored.

3. The motor driving circuit according to claim 1, wherein the storage unit stores the relationship data between the duty ratio of the input pulse-width-modulation and the targeted speed in a look up table form.

4. The motor driving circuit according to claim 2, wherein the storage unit stores the relationship data between the duty ratio of the input pulse-width-modulation and the targeted speed in a linear function form of the targeted speed with respect to the duty ratio of the input pulse-width-modulation.

5. The motor driving circuit according to claim 4, wherein the linear function of the targeted speed with respect to the duty ratio of the input pulse-width-modulation is represented by the following <Equation>.
Targeted speed=Duty ratio of input pulse-width-modulation×Slope a+Constant b, <Equation>
where b is a minimum value of the targeted speed.

6. The motor driving circuit according to claim 2, wherein the storage unit stores the relationship data between the duty ratio of the input pulse-width-modulation and the targeted speed in a form in which the look up table and the linear function of the targeted speed with respect to the duty ratio of the input pulse-width-modulation are combined with each other.

7. The motor driving circuit according to claim 5, wherein the relationship data between the duty ratio of the input pulse-width-modulation and the targeted speed is configured in a form in which a plurality of linear functions having different slopes for each section of the duty ratio of the input pulse-width-modulation are combined with one another.

8. The motor driving circuit according to claim 1, wherein the driving control unit includes:
a detector that detects the targeted speed corresponding to the duty ratio of the input pulse-width-modulation by using the relationship data between the duty ratio of the input pulse-width-modulation and the targeted speed; and
a comparator that compares the speed of the motor with the targeted speed to ouput the comparison results.

9. The motor driving circuit according to claim 8, wherein the driving control unit further includes:
a controller that controls a duty ratio of a driving signal applied to the motor by using the comparison results; and
a driver that controls the driving of the motor so that the speed of the motor becomes the targeted speed by using the duty ratio of the driving signal.

10. The motor driving circuit according to claim 9, wherein the controller performs a control to reduce the duty ratio of the driving signal when the speed of the motor is faster than the targeted speed in the comparison results and performs a control to increase the duty ratio of the driving signal when the speed of the motor is slower than the targeted speed in the comparison results.

11. The motor driving circuit according to claim 1, wherein the relationship data between the duty ratio of the input pulse-width-modulation and the targeted speed is stored by previously reflecting error information for compensating for errors of the speed of the motor detected by the speed detection unit or the duty ratio of the input pulse-width-modulation detected by the duty detection unit.

12. A motor driving apparatus, comprising:
an external control circuit that generates and outputs input pulse-width-modulation as a command for controlling a motor at a desired speed; and
a motor driving circuit that receives the input pulse-width-modulation to detect a duty ratio of the input pulse-width-modulation, detects a speed of the motor, detects a targeted speed corresponding to the duty ratio of the input pulse-width-modulation by using relationship data between the duty ratio of the input pulse-width-modulation and the targeted speed that are previously stored, and controls a driving of the motor so that the speed of the motor is equal to the targeted speed.

13. The motor driving apparatus according to claim 12, wherein the motor driving circuit includes a storage unit in which the relationship data between the duty ratio of the input pulse-width-modulation and the targeted speed are stored.

14. The motor driving apparatus according to claim 13, wherein the storage unit stores the relationship data between the duty ratio of the input pulse-width-modulation and the targeted speed in a look up table form.

15. The motor driving apparatus according to claim 13, wherein the storage unit stores the relationship data between the duty ratio of the input pulse-width-modulation and the targeted speed in a linear function form of the targeted speed with respect to the duty ratio of the input pulse-width-modulation.

16. The motor driving apparatus according to claim 15, wherein the linear function of the targeted speed with respect to the duty ratio of the input pulse-width-modulation is represented by the following <Equation>.
Targeted speed=Duty ratio of input pulse-width-modulation×Slope a+Constant b, <Equation>
where b is a minimum value of the targeted speed.

17. The motor driving apparatus according to claim 13, wherein the storage unit stores the relationship data between the duty ratio of the input pulse-width-modulation and the targeted speed in a form in which the look up table and the linear function of the targeted speed with respect to the duty ratio of the input pulse-width-modulation are combined with each other.

18. The motor driving apparatus according to claim 16, wherein the relationship data between the duty ratio of the input pulse-width-modulation and the targeted speed are formed in a form in which plurality of different linear functions having different slopes for each section of the duty ratio of the input pulse-width-modulation are combined with one another.

19. A motor driving method, comprising:
detecting a duty ratio of input pulse-width-modulation applied to control a speed of a motor;
detecting the speed of the motor;
detecting a targeted speed corresponding to the duty ratio of the input pulse-width-modulation by using relationship data between the duty ratio of the input pulse-width-modulation and a targeted speed that are previously stored; and
controlling a driving of the motor so that the speed of the motor is equal to the targeted speed.

20. The motor driving method according to claim 19, further comprising: after the detecting of the targeted speed, comparing the speed of the motor with the targeted speed to output the comparison results.

21. The motor driving method according to claim 20, wherein at the controlling of the driving of the motor, the duty ratio of the driving signal applied to the motor is controlled by using the comparison results.

22. The motor driving method according to claim 21, wherein at the controlling of the duty ratio of the driving signal,
a control is performed to reduce the duty ratio of the driving signal when the speed of the motor is faster than the targeted speed in the comparison results and
a control is performed to increase the duty ratio of the driving signal when the speed of the motor is slower than the targeted speed in the comparison results.
